(19) United States
(12) Patent Application Publication
(10) Pub. No.: US 2014/0038613 A1
(43) Pub. Date: Feb. 6, 2014

(54) Method and Apparatus

(71) Applicants: Antti Anton Toskala, Espoo (FI); Hannu Pekka Matias Vaitovirta, Espoo (FI); Harri Kalevi Holma, Helsinki (FI)

(72) Inventors: Antti Anton Toskala, Espoo (FI); Hannu Pekka Matias Vaitovirta, Espoo (FI); Harri Kalevi Holma, Helsinki (FI)

(73) Assignee: Nokia Siemens Networks Oy, Espoo (FI)

(21) Appl. No.: 14/110,480

(22) PCT Filed: Apr. 11, 2011
(86) PCT No.: PCT/EP11/55602

§ 371 Date: Oct. 8, 2013

(51) Int. Cl. H04W 36/20

(52) U.S. Cl. CPC H04W 36/20
USPC 455/436

(57) ABSTRACT

A method including determining a user equipment which is interfering with a target base station from a reference signal transmitted by said user equipment; and causing a message to be sent to a source base station including information identifying said user equipment.

The invention relates a method and apparatus and in particular but not exclusively to a method and apparatus for use where handover is required.

A communication system can be seen as a facility that enables communication sessions between two or more entities such as fixed or mobile communication devices, base stations, servers and/or other communication nodes. A communication system and compatible communicating entities typically operate in accordance with a given standard or specification which sets out what the various entities associated with the system are permitted to do and how that should be achieved. For example, the standards, specifications and related protocols can define the manner how communication devices can access the communication system and how various aspects of communication shall be implemented between communicating devices. A communication can be carried on wired or wireless carriers. In a wireless communication system at least a part of the communication between at least two stations occurs over a wireless link.

Examples of wireless systems include public land mobile networks (PLMN) such as cellular networks, satellite based communication systems and different wireless local networks, for example wireless local area networks (WLAN). A wireless system can be divided into cells, and hence these are often referred to as cellular systems. A cell is provided by a base station. Cells can have different shapes and sizes. A cell can also be divided into sectors. Regardless of the shape and size of the cell providing access for a user equipment, and whether the access is provided via a sector of a cell or a cell, such area can be called radio service area or access area. Neighbouring radio service areas typically overlap, and thus a communication in an area can listen to more than one base station.

A user can access the communication system by means of an appropriate communication device. A communication device of a user is often referred to as user equipment (UE) or terminal. A communication device is provided with an appropriate signal receiving and transmitting arrangement for enabling communications with other parties. Typically a communication device is used for enabling receiving and transmission of communications such as speech and data. In wireless systems a communication device provides a transceiver station that can communicate with another communication device such as e.g. a base station of an access network and/or another user equipment. The communication device may access a carrier provided by a station, for example a base station, and transmit and/or receive communications on the carrier.

An example of communication systems attempting to satisfy the increased demands for capacity is an architecture that is being standardized by the 3rd Generation Partnership Project (3GPP). This system is often referred to as the long-term evolution (LTE) of the Universal Mobile Telecommunications System (UMTS) radio-access technology. The LTE aims to achieve various improvements, for example reduced latency, higher user data rates, improved system capacity and coverage, reduced cost for the operator and so on. A further development of the LTE is often referred to as LTE-Advanced.

The various development stages of the 3GPP LTE specifications are referred to as releases.

In LTE-Advanced the network nodes can be wide area network nodes such as a macro eNode B (eNB) which may, for example, provide coverage for an entire cell. A user equipment which is associated with a source cell may be handed over to a target cell.

According to an aspect, there is provided a method comprising determining a user equipment which is interfering with a target base station from a reference signal transmitted by said user equipment; and causing a message to be sent to a source base station comprising information identifying said user equipment.

In one embodiment, the method may comprise receiving information from said source base station indicating which reference signal is used by which user equipment.

In another embodiment, a reference signal may comprise a sounding reference signal.

In another embodiment, said determining may comprise measuring interference caused by said user equipment.

In another embodiment, the method may comprise determining that said user equipment is to be handed over to the target base station.

In another embodiment, the message may comprise information indicating that said user equipment is to be handed over to said target base station.

In a further embodiment, the method may comprise causing a handover command to be sent to said user equipment.

In another embodiment, said handover command may have a same format as a handover command sent by said source base station to said user equipment.

In another embodiment, the method may comprise causing said target base station to keep a first physical resource providing a relatively low interference level whereby a handover command is sent to said user equipment from said source base station on a second physical resource of the source base station while said first physical resource is providing a relatively low interference.

In another embodiment, the method may comprise receiving information indicating the first physical resource providing a relatively low interference in the target base station.

In another embodiment, the method may comprise receiving information indicating a time at which said first physical resource is to provide said relatively low interference level.

In another embodiment, the method may cause said target base station to keep a first physical resource providing a relatively low interference level comprises keeping said first physical resource free.

In another embodiment, the first and second physical resources may be physical resource blocks.

In another embodiment, said first and second physical resource blocks may be at substantially a same frequency.

In another embodiment, the method may comprise performing the method in a target base station.

In another embodiment, a method may comprise providing reference signal information to a target base station for a user equipment; receiving information indicating that said user equipment is causing interference to said target base station; and causing a handover command to be sent to said user equipment.

In another embodiment, said reference signal information may comprise sounding reference signal information.

In another embodiment, said handover command may have a same format as a handover command sent by said target base station to said user equipment.

In another embodiment, the method may comprise causing said target base station to reduce interference provided by or keep free a first physical resource; and causing said handover command to be sent to said user equipment on a second physical resource of a source base station while said first physical resource is free or is providing reduced interference.

In another embodiment, the method may cause said target base station to keep free or reducing interference provided by said first physical resource comprises causing a message to be sent to said target base station

In another embodiment, said message may comprise at least one of information from which said first physical resource is identifiable and timing information.

In another embodiment, the first and second physical resources may be physical resource blocks.

In another embodiment, the first and second physical resource blocks may be at substantially a same frequency.

In another embodiment, the method may comprise causing said handover command to be sent in response to receipt of an acknowledgement of said message being received from said target base station.

In another embodiment, said causing of said handover command to be sent may comprise causing a retransmission of handover command.

In another embodiment, the method may comprise performing the method in a source base station.

In another embodiment, a computer program may comprise executable instructions which when performed by one or more processors cause the method to be performed.

In further embodiment, an apparatus may comprise means for determining a user equipment which is interfering with a target base station from a reference signal transmitted by said user equipment; and means for causing a message to be sent to a source base station comprising information identifying said user equipment.

In another embodiment, an apparatus may comprise means for receiving information from said source base station indicating which reference signal is used by which user equipment.

In another embodiment, said reference signal may comprise a sounding reference signal.

In another embodiment, said determining means may be configured to measure interference caused by said user equipment.

In another embodiment, the apparatus may comprise means for determining that said user equipment is to be handed over to the target base station.

In another embodiment, said message may comprise information indicating that said user equipment is to be handed over to said target base station.

In another embodiment, the apparatus may comprise means for causing a handover command to be sent to said user equipment.

In another embodiment, said handover command may have a same format as a handover command sent by said source base station to said user equipment.

In another embodiment, the apparatus may comprise means for causing said target base station to keep a first physical resource providing a relatively low interference level whereby a handover command is sent to said user equipment from said source base station on a second physical resource of the source base station while said first physical resource is providing a relatively low interference.

In another embodiment, the apparatus may comprise means for receiving information indicating the first physical resource providing a relatively low interference in the target base station.

In another embodiment, the apparatus may comprise means for receiving information indicating a time at which said first physical resource is to provide said relatively low interference level.

In another embodiment, said causing means may be configured to cause said target base station to keep said first physical resource free.

In another embodiment, said first and second physical resources may be physical resource blocks.

In another embodiment, said first and second physical resource blocks may be at substantially a same frequency.

In a further embodiment, a target base station may comprise the apparatus.

In another embodiment, an apparatus may comprise means for providing reference signal information to a target base station for a user equipment; means for receiving information indicating that said user equipment is causing interference to said target base station; and means for causing a handover command to be sent to said user equipment.

In another embodiment, said reference signal information may comprise sounding reference signal information.

In another embodiment, said handover command may have a same format as a handover command sent by said target base station to said user equipment.

In another embodiment, an apparatus may comprise means for causing said target base station to reduce interference provided by or keep free a first physical resource; and means for causing said handover command to be sent to said user equipment on a second physical resource of a source base station while said first physical resource is free or is providing reduced interference.

In another embodiment, said means may cause said target base station to keep free or reducing interference provided by said first physical resource is configured to cause a message to be sent to said target base station

In another embodiment, said message may comprise at least one of information from which said first physical resource is identifiable and timing information.

In another embodiment, said first and second physical resources may be physical resource blocks.

In another embodiment, said first and second physical resource blocks may be at substantially a same frequency.

In another embodiment, the apparatus may comprise means for causing said handover command to be sent in response to receipt of an acknowledgement of said message being received from said target base station.

In another embodiment, said means for causing of said handover command to be sent may be configured to cause a retransmission of handover command.

In a further embodiment, a source base station may comprise the apparatus.

In another embodiment, an apparatus may comprise at least one processor and at least one memory including computer program code, the at least one memory and computer program code configured, with the at least one processor, to cause the apparatus to: determine a user equipment which is interfering with a target base station from a reference signal transmitted by said user equipment; and cause a message to be sent to a source base station comprising information identifying said user equipment.

In another embodiment, an apparatus may comprise at least one processor and at least one memory including computer program code, the at least one memory and computer program code configured, with the at least one processor, to cause the apparatus to: provide reference signal information to a target base station for a user equipment; receive information indicating that said user equipment is causing interference to said target base station; and cause a handover command to be sent to said user equipment.

According to another embodiment, there is provided a method comprising: causing a target base station to reduce interference provided by a first physical resource of said target base station; and causing a handover command to be sent to a user equipment from a source base station on a second physical resource of the source base station while said first physical resource is providing a reduced interference.

According to another embodiment, there is provided an apparatus comprising: means for causing a target base station to reduce interference provided by a first physical resource of said target base station; and means for causing a handover command to be sent to a user equipment from a source base station on a second physical resource of the source base station while said first physical resource is providing a reduced interference.

According to another embodiment, there is provided an apparatus comprising at least one processor and at least one memory including computer program code, the at least one memory and computer program code configured, with the at least one processor, to cause the apparatus to: cause a target base station to reduce interference provided by a first physical resource of said target base station; and cause a handover command to be sent to a user equipment from a source base station on a second physical resource of the source base station while said first physical resource is providing a reduced interference.

Causing the target base station to reduce interference provided by said first physical resource may comprise causing a message to be sent to said target base station.

The reduced interference may be provided by keeping the first physical resource substantially free.

The message may comprise information from which said first physical resource is identifiable and/or information about when said interference is to be reduced on said first physical resource.

The first and second physical resources may be physical resource blocks.

The first and second physical resource blocks may be at substantially a same frequency.

Some embodiments may comprise causing said handover command to be sent in response to receipt of an acknowledgement of said message being received from said target base station.

The causing of said handover command to be sent may comprise causing a retransmission of the handover command.

The method may be performed by a computer program comprising computer executable instructions which when executed cause the method to be performed.

The method may be performed in a source base station. The apparatus may be provided in a source base station.

According to another embodiment there is provided a method comprising: receiving information indicating that a first physical resource is to provide a reduced interference in a target base station; and reducing interference provided by said first physical resource in said target base station such that a handover command is sent to a user equipment from a source base station on a second physical resource of the source base station while said first physical resource is providing a reduced interference.

According to another embodiment there is provided an apparatus comprising: means for receiving information indicating that a first physical resource is to provide a reduced interference in a target base station; and means for reducing interference provided by said first physical resource in said target base station such that a handover command is sent to a user equipment from a source base station on a second physical resource of the source base station while said first physical resource is providing a reduced interference.

According to another embodiment, there is provided an apparatus comprising at least one processor and at least one memory including computer program code, the at least one memory and computer program code configured, with the at least one processor, to cause the apparatus to: receive information indicating that a first physical resource is to provide a reduced interference in a target base station; and reduce interference provided by said first physical resource in said target base station such that a handover command is sent to a user equipment from a source base station on a second physical resource of the source base station while said first physical resource is providing a reduced interference.

Embodiments will now be described in further detail, by way of example only, with reference to the following examples and accompanying drawings, in which:

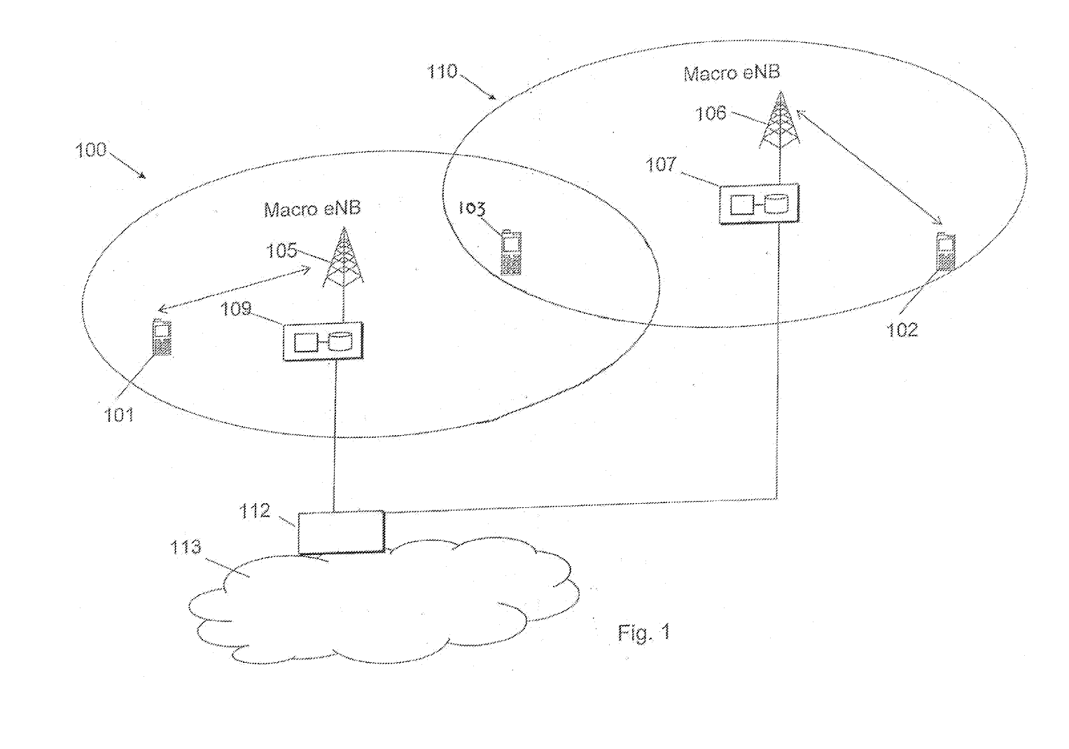

FIG. 1 shows a schematic diagram of a network according to some embodiments;

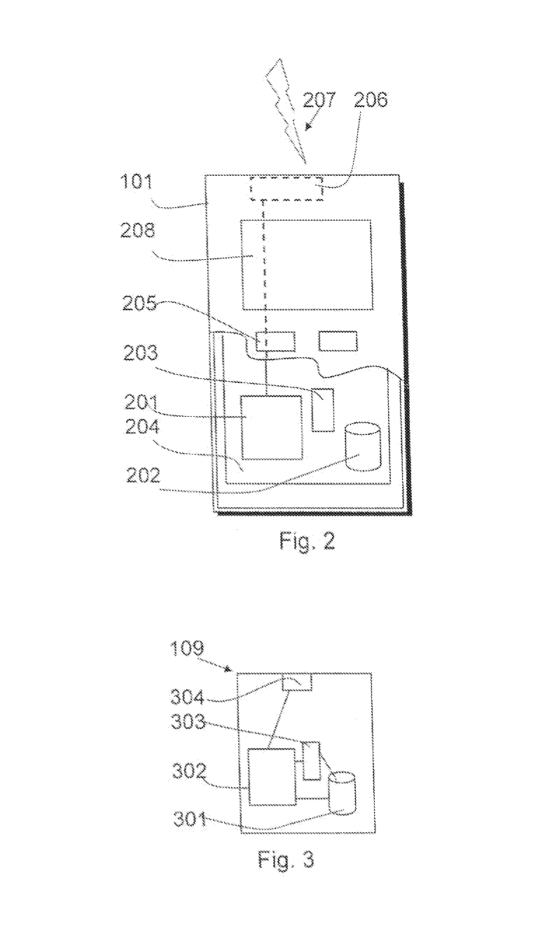

FIG. 2 shows a schematic diagram of a mobile communication device according to some embodiments;

FIG. 3 shows a schematic diagram of a control apparatus according to some embodiments;

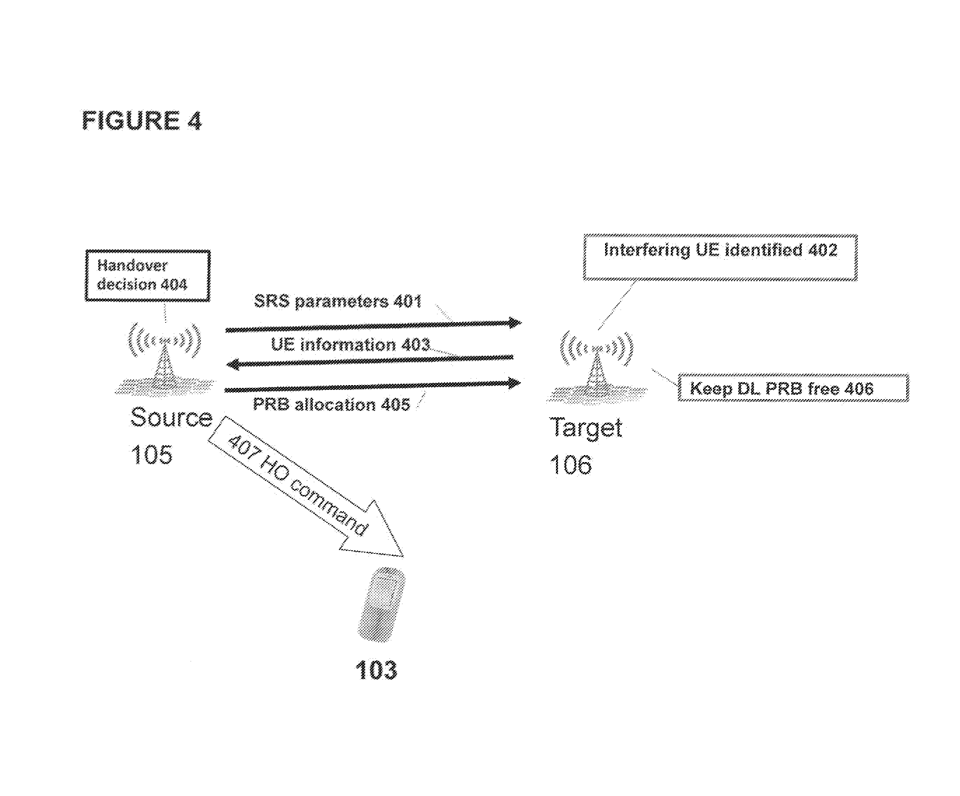

FIG. 4 shows a first embodiment; and

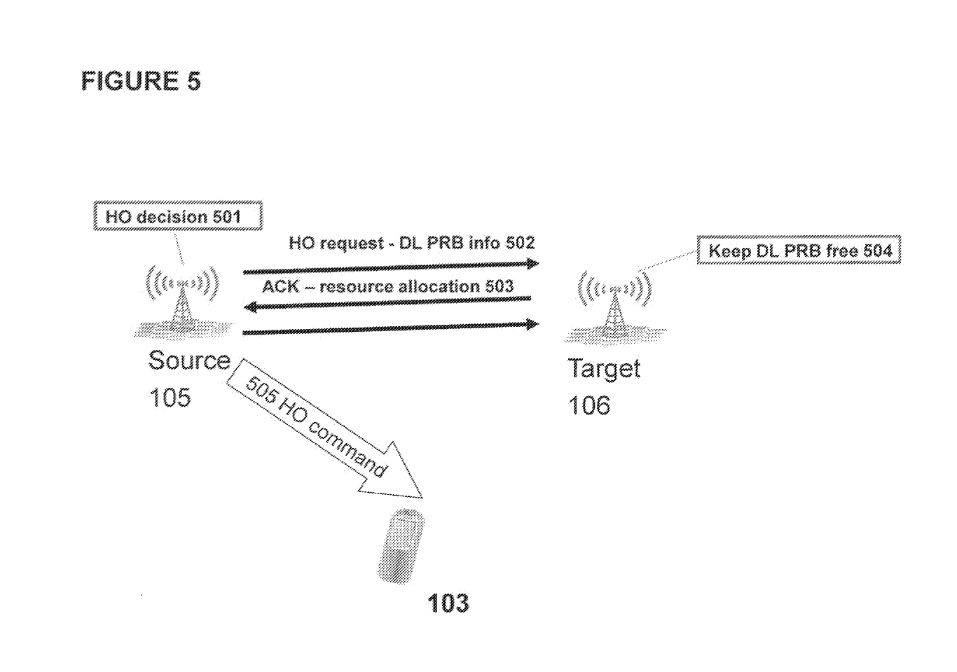

FIG. 5 shows a second embodiment.

In the following certain exemplifying embodiments are explained with reference to a wireless or mobile communication system serving mobile communication devices. Before explaining in detail the exemplifying embodiments, certain general principles of a wireless communication system, access systems thereof, and mobile communication devices are briefly explained with reference to FIGS. 1 to 3 to assist in understanding the technology underlying the described examples.

A communication device or user equipment 101, 102, 103, is typically provided wireless access via at least one base station or similar wireless transmitter and/or receiver node of an access system. In FIG. 1 two neighbouring and overlapping access systems or radio service areas 100, 110 are shown being provided by base stations 105, 106.

However, it is noted that instead of two access systems, any number of access systems can be provided in a communication system. An access system can be provided by a cell of a cellular system or another system enabling a communication device to access a communication system. A base station site 105, 106 can provide one or more cells. A base station can also provide a plurality of sectors, for example three radio sectors, each sector providing a cell or a subarea of a cell. All sectors within a cell can be served by the same base station. A radio link within a sector can be identified by a single logical identification belonging to that sector. Thus a base station can provide one or more radio service areas. Each communication device 101, 102, 103, and base station 105, 106 may have one or more radio channels open at the same time and may send signals to and/or receive signals from more than one source.

Base stations 105, 106, are typically controlled by at least one appropriate controller apparatus 109, 107 so as to enable operation thereof and management of mobile communication devices 101, 102, 103, in communication with the base stations 105, 106, 108. The control apparatus 107, 109 can be interconnected with other control entities. The control apparatus 107, 109 can typically be provided with memory capacity 301 and at least one data processor 302. The control apparatus 107, 109 and functions may be distributed between a plurality of control units. In some embodiments, each base station 105, 106 can comprise a control apparatus 109, 107. In alternative embodiments, two or more base stations may share a control apparatus. Currently LTE does not have a separate radio network controller. In some embodiments the control apparatus may be respectively provided in each base station.

The cell borders or edges are schematically shown for illustration purposes only in FIG. 1. It shall be understood that the sizes and shapes of the cells or other radio service areas may vary considerably from the similarly sized omnidirectional shapes of FIG. 1.

In particular, FIG. 1 depicts two wide area base stations 105, 106, which can be macro-eNBs 105, 106. The macro-eNBs 105, 106 transmit and receive data over the entire coverage of the cells 100 and 110 respectively. Alternatively, in LTE-Advanced, network nodes can be small area network nodes such as Home eNBs (HeNB) (femto cells) or pico eNodeBs (picoeNB). HeNBs may be configured to support local offload and may support any UE or UEs belonging to a closed subscriber group (CSG) or an open subscriber group (OSG). In some instances a combination of wide area network nodes and small area network nodes can be deployed using the same frequency carriers (e.g. co-channel deployment). The coverage of the smaller area base station is generally smaller than the coverage of the wide area base stations 105, 106. The coverage provided by smaller area nodes (pico or femto nodes) may overlap with the coverage provided by the macro-eNBs. Pico eNBs can be used to extend coverage of the macro-eNBs outside the original cell coverage of the macro-eNBs. The pico eNB can also be used to provide cell coverage in “gaps” or “shadows” where there is no coverage within the existing cells and/or may serve “hot spots”. In some embodiments, the smaller area node can be a femto or Home eNB which can provide coverage for a relatively small area such as the home. Some environments may have both pico and femto cells.

As shown, the radio service areas can overlap. Thus signals transmitted in an area can interfere with communications in another area.

The communication devices 101, 102, 103, can access the communication system based on various access techniques, such as code division multiple access (CDMA), or wideband CDMA (WCDMA). Other examples include time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

Some non-limiting examples of the recent developments in communication systems are the long-term evolution (LTE) of the Universal Mobile Telecommunications System (UMTS) that is being standardized by the 3rd Generation Partnership Project (3GPP). As explained above, further development of the LTE is referred to as LTE-Advanced. Non-limiting examples of appropriate access nodes are a base station of a cellular system, for example what is known as NodeB (NB) in the vocabulary of the 3GPP specifications. The LTE employs a mobile architecture known as the Evolved Universal Terrestrial Radio Access Network (E-UTRAN). Base stations of such systems are known as evolved Node Bs (eNBs) and may provide E-UTRAN features such as user plane Radio Link Control/Medium Access Control/Physical layer protocol (RLC/MAC/PHY) and control plane Radio Resource Control (RRC) protocol terminations towards the user devices. Other examples of radio access system include those provided by base stations of systems that are based on technologies such as wireless local area network (WLAN) and/or WiMax (Worldwide Interoperability for Microwave Access).

In FIG. 1 the base stations 105, 106, of the access systems can be connected to a wider communications network 113. The controller apparatus 107, 109 may be provided for coordinating the operation of the access systems. A gateway function 112 may also be provided to connect to another network via the network 113. The smaller base station 108 can also be connected to the other network by a separate gateway function 111. The base stations 105, 106, can be connected to each other by a communication link for sending and receiving data. The communication link can be any suitable means for sending and receiving data between the base stations 105, 106 and in some embodiments the communication link is an X2 link.

The other network may be any appropriate network. A wider communication system may thus be provided by one or more interconnect networks and the elements thereof, and one or more gateways may be provided for interconnecting various networks.

The communication devices will now be described in more detail with reference to FIG. 2. FIG. 2 shows a schematic, partially sectioned view of a communication device 101 that a user can use for communication. Such a communication device is often referred to as user equipment (UE) or terminal. An appropriate communication device may be provided by any device capable of sending and receiving radio signals. The communication device may be mobile. Non-limiting examples of a communication device include a mobile station (MS) such as a mobile phone or what is known as a ‘smart phone’, a portable computer provided with a wireless interface card or other wireless interface facility, personal data assistant (PDA) provided with wireless communication capabilities, or any combinations of these or the like. A communication device may provide, for example, communication of data for carrying communications such as voice, electronic mail (email), text message, multimedia and so on. Users may thus be offered and provided numerous services via their communication devices. Non-limiting examples of these services include two-way or multi-way calls, data communication or multimedia services or simply an access to a data communications network system, such as the Internet. Users may also be provided broadcast or multicast data. Non-limiting examples of the content include downloads, television and radio programs, videos, advertisements, various alerts and other information.

The communication device 101 may receive signals over an air interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is also typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204.

The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

FIG. 3 shows an example of a control apparatus 109 (or 107) for a communication system, for example to be coupled to, included in and/or for controlling a station of an access system. In some embodiments the base stations 105, 106, each comprise a separate control apparatus such as shown in FIG. 3. The control apparatus 109 can be arranged to provide control of communications by communication devices that are in the service area of the system. The control apparatus 109 can be configured to provide control functions in association with generation and communication of transmission patterns and other related information and for muting signals by means of the data processing facility in accordance with certain embodiments described below. For this purpose the control apparatus 109 comprises at least one memory 301, at least one data processing unit 302, 303 and an input/output interface 304. Via the interface the control apparatus can be coupled to a receiver and a transmitter of the base station. The control apparatus 109 can be configured to execute an appropriate software code to provide the control functions.

The LTE system currently has frequency reuse where neighbouring cells use the same frequency. Therefore, the inter-cell interference may be high at the cell edge and this may limit the available data rates. Currently LTE radio uses transmission and reception from one cell at a time. Currently no soft handover has been defined for LTE. Another issue for cell edge performance is handover delay and/or hysteresis. Typical handover latency may be more than 1 second due to measurement averaging. The handover hysteresis maybe typically 4 dB, which means that the target cell must be 4 dB better than the current cell before handover is executed. Therefore, UE may not always be connected to the best cell at the cell edge conditions. Cell edge performance may be affected by one or more of the following:

frequency reuse may makes inter-cell interference high;
handover delay may cause the UE to be connected to the non-optimal cell; and
handover hysteresis may cause the UE to be connected to a non-optimal cell.

The issues may, if combined with high speed mobility, cause call drops. The connection may get dropped after UE has sent a measurement report but before UE has received the reconfiguration command from old eNodeB.

Soft handover is used in WCDMA and HSUPA (High Speed Uplink Packet Access) but at the moment is not being proposed with LTE. Site selection transmit diversity has been defined in 3GPP Release 99 but was not implemented and removed in Release 5. Coordinated multipoint transmission (CoMP) has been studied in Release 10 and 11. The study item assumed high capacity and low delay transport connection. Enhanced serving cell change has been proposed in HSDPA (High Speed Downlink Packet Access). “Forward” handover has been proposed where the context of the UE is fetched by the new eNodeB after RLF (radio link failure) has occurred and re-establishement (reconnection) has taken place. RLF means Radio Link Failure, i.e. when a connection is dropped and the UE then connects to network again, via a different cell as it was moving. This new cell will fetch the content from the old cell thus making the re-establishement faster.

In contrast, some embodiments have that the nearby cells try to identify themselves, based on the SRS being sent in the uplink, which UE is coming close to them. This may before a measurement report is triggered (which may come later due to the hysteresis as discussed above.

Reference is first made to FIG. 4. This shows schematically a source eNB 105 and a target eNB 106. UE 103 is in an area of overlap between the cells of the source and target eNBs, as can be seen from FIG. 1. The UE is currently served by the source eNB 105. FIG. 4 shows the use of the SRS pattern to identify the interfering UE and the allocation of resources to ensure that the UE receives the HO command correctly. FIG. 4 generally illustrates a method according to an embodiment.

In some embodiments, the source eNodeB will inform the neighbouring eNodeBs of the SRS (sounding reference signal) patterns/symbol sequences used by the UEs (all of them or only ones in the cell edge area). A sounding reference pattern is a know pattern of symbols or a known signal. As shown in FIG. 4, the source eNB 105 sends the SRS parameters for the UEs to the target eNB. This is referenced 401.

The sounding reference signal (SRS) may be transmitted to find a best resource unit (RU), also known as a resource block (RB) or physical resource block (PRB) in the LTE standard for transmitting from a user equipment (UE). The SRS may enable channel aware scheduling and fast link adaptation for PUSCH for UL data transmissions. The SRS may also be used as a reference (RS) for closed loop power control (PC) for at least one of the physical uplink shared channel (PUSCH) and the physical uplink control channel (PUSCH).

As referenced 402, the neighbouring eNodeBs will search for the SRS pattern in order to identify a UE that is causing high uplink interference to that neighbouring eNodeB. In other words, a UE which has a high interference level to the target is identified based on the SRS pattern which that UE is using. The target eNB will therefore be measuring the interference caused by at least some of the UEs. Due to hysteresis the UE may be better with one of the neighbouring eNodeBs than the serving one. Interference in the frequency domain may also have an impact. The SRS pattern the UE sends in the uplink is known a priori and thus it is easier to use this pattern to identify or measure one particular UE as the target BTS knows what is going to be transmitted and when. Thus a UE is identified based on the SRS transmission (the SRS transmission will follow a configured pattern, unlike the actual uplink data transmission).

If a UE is causing interference, the following may be done to improve handover reliability: The expected target eNodeB will inform the source eNodeB of the likely need for handover (which can then trigger handover). The target eNB may have information identifying the source eNB with which the interfering UE is associated. The target eNB may send a handover indication or information from which the source eNB can make a decision as to whether or not to handover the UE. For example as referenced 403, the target eNB send information about the interfering UE. The information may be identity information and/or interference information. The interference information may be information about the level of interference and/or an indication that the UE is interfering at a level such that handover is required. Alternatively or additionally the target eNB may send a request for the UE to be handed over from the source eNB to the target eNB.

The source eNodeB may alternatively modify the hysteresis value for such a UE that is identified to cause interference, so that the measurement report is comes earlier.

As indicated by 404, the source eNB will make a handover decision that the UE is to be handed over from the source eNB to the target eNB.

As indicated by 405, the source eNB will send information to the target eNB indicating the DL physical resource block allocation for the handover command which will be used by the source eNB. This may optionally including associated time information for the DL physical resource block allocation.

As indicated by 406, the target eNB will keep the DL physical resource blocks which will be used by the source eNB to provide the handover command free or reduce the interference provided on those DL physical resource blocks. This may controlled to occur at the time indicated by the time information. This may improve the reliability of the delivery of the HO command from the source eNB to the UE as the interference from the target eNB may be reduced.

The delivery of the handover command from the source eNB to the UE 103 is referenced 407.

Reference is made to FIG. 5 which again shows the source eNB 105, the target eNB 106 and the UE 103 which is to be handed over from the source eNB to the target eNB. This Figure shows the sending of the handover command to the target eNB with information about the DL PRB allocation for the HO command transmission. Again this Figure illustrates a method of an embodiment.

As reference 501, in FIG. 5, the source eNB makes a handover decision. This may be as described previously or may be based on a different mechanism.

As referenced 502, the source eNB sends to the target eNB the HO request and information indicating the downlink physical resource block allocation which will be used by the source eNB to send the HO request to the UE. Optionally timing information may be provided indicating when the source eNB will send the HO command.

As referenced 503, the target eNB will send an acknowledgement back to the source eNB for the HO request and the PRB allocation information.

As referenced 504, the target eNB will keep the downlink physical resource block allocation free to make sure that downlink transmissions in the target cell provide less interference to the HO command transmission from the source eNB to the UE. Alternatively the target eNB will reduce the interference levels provided by the downlink physical resource block. The downlink physical resource block may provide a reduced or relatively low interference level to the HO command transmission from the source eNB to the UE. The interference may be reduced or the resource block kept free at the time indicated by the timing information.

As reference 505, the source eNB send the HO command to the UE on the allocated DL PRB. This will cause the UE to be handed over from the source eNB to the target eNB.

It should be appreciated that in some embodiments, the HO command is sent after the HO decision, before the target eNB has kept the DL PRB free. This will prevent a delay in the sending of the HO command to the UE. However, the method is such that if a retransmission of the HO command is necessary, the target eNB will be able to keep the DL PRB for the retransmission of the HO command free.

In one embodiment the expected target eNodeB can inform the source eNodeB which downlink resources to use to send the handover command to the UE. Alternatively the source eNB will inform the target as to which DL resources to keep free as the corresponding resources are used by the source eNB to transmit the HO command to the UE.

Thus in some embodiments, the target eNodeB can avoid transmission in that part of the resources to ensure the handover command is reliable received by the UE from the source eNB. In some embodiments, the uplink resources can be temporally arranged so that interference is avoided.

In some embodiments, the target eNB may send the HO command. This may be alternatively or in addition to the HO command being sent by the source eNB. The target eNB may send the same HO command to the eNB.

It should be appreciated that aspects of the arrangement of FIGS. 4 and 5 may be used together or separately. It should be noted that any one or more of the steps of FIG. 4 may be combined with any one or more steps of FIG. 5, in some embodiments.

The source eNB and target eNB may communicate in any suitable way. By way of example the source eNB and target eNB may communicate via an X2 connection.

In case of a synchronized network, the target eNodeB may send the handover command to the UE using the source eNodeB TX formats etc (SFN single frequency network) in the same resources if aligned with the source eNodeB. A SFN is one where both base stations may send the same content.

In embodiment, the HO command is delayed (or the associated retransmission is timed) so that the corresponding resources of the target eNB are free.

It should be appreciated that in some methods may have the steps performed in the numerical order, eg 401, 402 . . . 407 or 501, 502, . . . 505. However it should be appreciated that in other embodiments, the steps may be performed in a different order. By way of example only, the order may be changed if the method is used for retransmission of a HO command. Alternatively or additionally, one or more of the steps shown may be omitted. Alternatively or additionally, one or more additional steps may take place.

It is noted that whilst embodiments have been described in relation to LTE-Advanced, similar principles can be applied to any other communication system or indeed to further developments with LTE. Also, instead of carriers provided by a base station a carrier comprising may be provided by a communication device such as a mobile user equipment. For example, this may be the case in application where no fixed equipment provided but a communication system is provided by means of a plurality of user equipment, for example in adhoc networks. Therefore, although certain embodiments were described above by way of example with reference to certain exemplifying architectures for wireless networks, technologies and standards, embodiments may be applied to any other suitable forms of communication systems than those illustrated and described herein. In some other embodiments the aforementioned embodiments can be adopted to orthogonal frequency division multiple access (OFDMA) frequency division duplex (FDD) based mobile communication system other than LTE.

The required data processing apparatus and functions of a base station apparatus, a communication device and any other appropriate apparatus may be provided by means of one or more data processors. The described functions at each end may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non limiting examples. The data processing may be distributed across several data processing modules. A data processor may be provided by means of, for example, at least one chip. Appropriate memory capacity can also be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the communication device, base station and/or control apparatus such as in the processor entity, or by hardware, or by a combination of software and hardware.

Further in this regard it should be noted that steps in the Figures may represent program steps, or interconnected logic circuits, blocks and functions, or a combination of program steps and logic circuits, blocks and functions. Different steps may be performed in different apparatus. The software may be stored on such physical media as memory chips, or memory blocks implemented within the processor, magnetic media such as hard disk or floppy disks, and optical media such as for example DVD and the data variants thereof, CD.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more of any of the other embodiments previously discussed.

1-55. (canceled)

56. A method comprising:
determining a user equipment which is interfering with a target base station from a reference signal transmitted by said user equipment; and
causing a message to be sent to a source base station comprising information identifying said user equipment.

57. A method as claimed in claim 56, comprising: receiving information from said source base station indicating which reference signal is used by which user equipment.

58. A method as claimed in claim 57, wherein said reference signal comprises a sounding reference signal.

59. A method as claimed in claim 56, wherein said message comprises information indicating that said user equipment is to be handed over to said target base station.

60. A method as claimed in claim 59 comprising causing a handover command to be sent to said user equipment, wherein said handover command has a same format as a handover command sent by said source base station to said user equipment.

61. A method as claimed in claim 56, comprising causing said target base station to keep a first physical resource providing a relatively low interference level whereby a handover command is sent to said user equipment from said source base station on a second physical resource of the source base station while said first physical resource is providing a relatively low interference.

62. A method as claimed in claim 61, comprising receiving information indicating the first physical resource providing a relatively low interference in the target base station.

63. A method comprising:
providing reference signal information to a target base station for a user equipment;
receiving information indicating that said user equipment is causing interference to said target base station; and
causing a handover command to be sent to said user equipment.

64. A method as claimed in claim 63, wherein said reference signal information comprises sounding reference signal information.

65. A method as claimed in claim 63, comprising causing said target base station to reduce interference provided by or keep free a first physical resource; and causing said handover command to be sent to said user equipment on a second physical resource of a source base station while said first physical resource is free or is providing reduced interference.

66. A method as claimed in claim 65, wherein causing said target base station to keep free or reducing interference provided by said first physical resource comprises causing a message to be sent to said target base station, wherein said message comprises at least one of information from which said first physical resource is identifiable and timing information.

67. A method as claimed in claim 65, comprising causing said handover command to be sent in response to receipt of an acknowledgement of said message being received from said target base station.

68. A computer program comprising executable instructions which when performed by one or more processors cause the method of claim 56 to be performed.

69. An apparatus comprising at least one processor and at least one memory including computer program code, the at least one memory and computer program code configured, with the at least one processor, to cause the apparatus to:
determine a user equipment which is interfering with a target base station from a reference signal transmitted by said user equipment; and
cause a message to be sent to a source base station comprising information identifying said user equipment.

70. An apparatus comprising at least one processor and at least one memory including computer program code, the at least one memory and computer program code configured, with the at least one processor, to cause the apparatus to:
provide reference signal information to a target base station for a user equipment;
receive information indicating that said user equipment is causing interference to said target base station; and
cause a handover command to be sent to said user equipment.
